(19) United States
(12) Patent Application Publication
(10) Pub. No.: US 2006/0263492 A1
(43) Pub. Date: Nov. 23, 2006

(54) Produce packaging system and method of use

(76) Inventor: Daniel Whittles, Palm City, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/418,049

(22) Filed: May 3, 2006

Related U.S. Application Data
(60) Provisional application No. 60/732,485, filed on Nov. 2, 2005.
(60) Provisional application No. 60/677,500, filed on May 4, 2005.

(51) Int. Cl. A23B 7/148

(52) U.S. Cl. 426/106

(57) ABSTRACT

Systems and methods that utilize a produce packaging tray for storing and transporting produce have been developed which are capable of storing and transporting produce such that the freshness and lifespan of the produce is consistently increased while the damage afflicted upon the produce being packaged is decreased. The produce packaging systems and methods also provide for consistent and appealing presentation of the produce as well as precision packaging of produce.

### CROSS REFERENCE TO RELATED APPLICATION

The present application claims the priority of U.S. provisional patent application No. 60/677,500 filed May 4, 2005, and U.S. provisional patent application No. 60/732,485 filed Nov. 2, 2005.

### FIELD OF THE INVENTION

The invention relates to systems and methods for packaging, storing, and transporting produce. More particularly, the invention relates to produce packaging trays, systems, and methods that extend the shelf life and freshness of the produce.

### BACKGROUND

Conventional methods for packaging fresh produce for transport from a produce packing facility to a wholesaler or retailer involve simply dispensing the individual produce pieces into a box and then sealing the box. The produce is typically dispensed into a box at a high rate of speed and with considerable force. The boxed produce is then transported by truck, train, or ship to the wholesaler's or retailer's location—a journey that might take several days depending on distance between the packer and wholesaler/retailer and the mode of transport. As a consequence of the packaging process, many of the produce pieces become bruised or crushed. This, coupled with the time the produce is in transit, results in a decline in the freshness and quality of the produce—reducing the wholesale/retail value of the produce. Produce packaged in this manner is also vulnerable to contamination during transport by airborne agents and other contaminants that cause illness in humans.

Accordingly, a system for packaging fresh produce that reduces deterioration of the produce and that reduces contamination of the produce by illness-causing agents, thus increasing safety for the consumer of the produce, would be beneficial.

### SUMMARY OF THE INVENTION

The invention relates to the development of systems and methods that utilize a produce packaging tray for storing and transporting produce. The systems and methods of the invention extend the freshness of and minimize damage to the produce, as well as reduce the risk of contamination of the produce by airborne agents and other contaminants that cause illness in humans. Because produce is packaged in a single layer within a packaging tray, the systems and methods further provide for consistent, appealing presentation and precision packaging of the produce. The system of the invention is especially useful for packaging and transporting delicate produce such as squash, zucchini, tomatoes, cucumbers, bell peppers, green beans, jalapeno peppers, peaches, apples, other tree fruit, eggplant, corn, and any vegetables with soft epidermal layers.

One example of a produce packaging tray as described herein is a tray having a substantially rectangular and rigid base and a plurality of rigid, uniformly spaced vertical ridges that extend upwards from the base and that are disposed parallel to each other. The ridges are disposed on the base so as to form a plurality of uniformly spaced channels that are each sized to accommodate several pieces of produce which can be disposed longitudinally to each other (i.e., in a head to tail configuration) within the channel, creating a single layer of produce within the tray. The apex of each ridge is blunt to prevent damage when the produce is loaded onto the tray. Another example of a produce packaging tray is a semi-rigid, one-piece structure formed by a base having four walls extending therefrom, the tray having a design similar to that of a cookie sheet. Produce that can be packaged using these and other trays described herein include fruits and vegetables, as well as hybrids thereof.

A typical method of packaging produce as described herein includes processing the produce (e.g., washing the produce), positioning the produce into packaging trays such that each tray contains a single layer of produce, and wrapping the produce-containing trays with a wrapping (e.g., a gas permeable plastic wrapping such as shrink wrap or plastic wrap) for preserving the safety, quality, freshness, cleanliness, orderliness, as well as the consistent and appealing look of the produce. Wrapping a produce-containing tray with a wrapping also facilitates handling of the tray; handling a plurality of such wrapped, produce-containing trays is easier than handling loosely-packed, bulk produce. After being wrapped, the trays are stacked one on top of the other in a container such as a cardboard carton for storage and transportation to a wholesaler or retailer. Once the above steps, which are typically performed in a packing facility, are completed, the container(s) containing the produce-containing trays are transported to a retailer, wholesaler, restaurant, or other entity that purchases produce. Although the systems and methods described herein may find particular use by entities that purchase large amounts of produce in bulk, they may also be used by entities or individuals purchasing smaller amounts of produce.

Accordingly, the invention features a a method of enhancing the safety and quality of delicate produce to be transported from a packaging facility to a wholesaler or retailer. The method includes the steps of, at a packaging facility: a) washing a plurality of pieces of recently harvested produce; b) positioning a first portion of the plurality of processed pieces of produce into at least a first tray and positioning a second portion of the plurality of processed pieces of produce into at least a second tray; c) wrapping the first portion of the plurality of pieces of produce and the at least first tray with a first piece of material; d) wrapping the second portion of the plurality of pieces of produce and the at least second tray with a second piece of material; e) placing the wrapped first and second trays into a container with the at least second tray stacked on top of the at least first tray; and f) loading the container aboard a vehicle for transport to the wholesaler or retailer. The delicate produce includes squash, zucchini, tomatoes, cucumbers, bell peppers, green beans, jalapeno peppers, peaches, apples, eggplant, and corn. The wholesaler or retailer can be located a distance greater than about 8 kilometers from the packaging facility, and a distance greater than about 804 kilometers from the packaging facility.

In this method, the at least first and second trays each include a semi-rigid structure formed by a base and a plurality of semi-rigid, uniformly spaced vertical ridges that each extend upwards from the base and that are disposed parallel to each other, the ridges disposed on the base to form a plurality of uniformly spaced channels that are each sized to accommodate at least two pieces of produce for storage and/or transport, the apex of each ridge being blunt. The step (b) of positioning a first portion of the plurality of pieces of produce into at least a first tray and positioning a second portion of the plurality of pieces of produce into at least a second tray includes positioning each piece of produce such that the first portion of the plurality of pieces of produce are disposed longitudinally to each other in the at least first tray and the second portion of the plurality of pieces of produce are disposed longitudinally to each other in the at least second tray. The first piece of material can be moisture impermeable, moisture permeable, gas permeable, and gas impermeable. The wrapped first tray can include a gas that modulates ripening of the produce. The at least first and second trays can each have a tab operably coupled thereto for facilitating lifting of the at least first and second trays from the container.

This method can further include affixing a first label containing information about the first portion of the plurality of processed pieces to the at least first tray and affixing a second label containing information about the second portion of the plurality of processed pieces to the at least second tray. The step b) of positioning a first portion of the plurality of processed pieces of produce into at least a first tray and positioning a second portion of the plurality of processed pieces of produce into at least a second tray can be performed manually or automatically.

Unless otherwise defined, all technical terms used herein have the same meaning as commonly understood by one of ordinary skill in the art to which this invention belongs. Although apparatuses, systems, and methods similar or equivalent to those described herein can be used in the practice or testing of the present invention, suitable apparatuses, systems and methods are described below. The particular embodiments discussed below are illustrative only and not intended to be limiting.

### BRIEF DESCRIPTION OF THE DRAWINGS

FIG. 1 is a top plan schematic of a representative tray of the invention.

FIG. 2 is a top plan view of a tray containing zucchini and squash, the tray and vegetables being sealed in a wrapping.

FIG. 3A is a top plan view of squash packed within a tray, shown placed within a cardboard carton.

FIG. 3B is an elevated side view (left side of figure) of zucchini packed within a tray, the tray and zucchini being sealed with a film wrapper. The right side of FIG. 3B is a top plan view of zucchini packed within a tray, shown placed within a cardboard carton, the tray and zucchini being sealed with a film wrapper.

FIG. 4A is a top plan schematic of a representative tray of the invention.

FIG. 4B is an end view of the tray of FIG. 4A.

FIG. 4C is a perspective view of the tray of FIGS. 4A and 4B.

FIG. 5 is a perspective view of zucchini packed within a tray, shown placed within a cardboard carton, the tray and zucchini being sealed with a film wrapper.

FIG. 6 is a perspective view of two trays of another embodiment of the invention, one tray a 5 down and the other tray a 10 down.

FIG. 7 is a perspective view of green bell peppers packed within a tray of the embodiment shown in FIG. 6, the tray being disposed within a cardboard box (carton).

### DETAILED DESCRIPTION

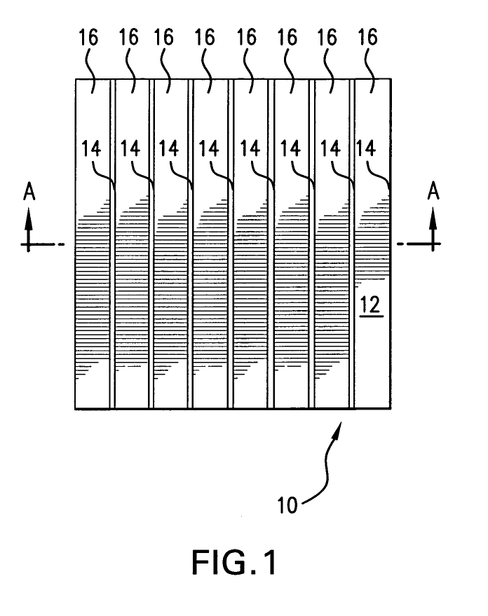

Referring generally to FIGS. 1-5, an embodiment of the system of the invention includes a tray 10 for holding produce. With particular reference to FIG. 1, the tray 10 is a semi-rigid, one-piece structure formed by a base 12 and a plurality of semi-rigid, uniformly spaced vertical ridges 14 that each extend upwards from the base 12 and that are disposed parallel to each other. The ridges 14 are disposed on the base 12 to form a plurality of uniformly spaced channels 16 that are each sized to accommodate one or more (e.g., 1, 2, 3, 4, 5, 6, 7, 8, or more) pieces of produce 18 for storage and/or transport. The apex of each ridge 14 is preferably blunt (e.g., rounded) to prevent the produce 18 from being damaged as it is loaded onto the tray 10. Within each channel 16, the pieces of produce are disposed longitudinally to each other (i.e., in a single-file, head to tail configuration). The tray 10 provides each piece of produce 18 its own protective compartment that prevents crushing or bruising by other pieces of produce 18 and by jostling while in transit.

The tray 10 is preferably formed from a material that provides sufficient rigidity to prevent structural bending when the tray is fully loaded with produce 18. The rigidity of the tray will depend upon the weight and dimensions of the produce to be packaged. The tray 10 is thus preferably made of PVC, polystyrene, polybutylene, nylon, reinforced cardboard (e.g., corrugated cardboard), plastic, thermoformed material, as well as combinations or composites of the foregoing, etc. Materials that are food-safe, temperature and moisture resistant are particularly useful. Trays 10 of the invention can be coated or lined with a food-safe coating or material, such as, for example, a paper, a solution, a plastic, etc. Food-safe coatings are well known in the art and any appropriate food-safe coating or material can be used in the invention. Trays as described herein can be made of recyclable materials.

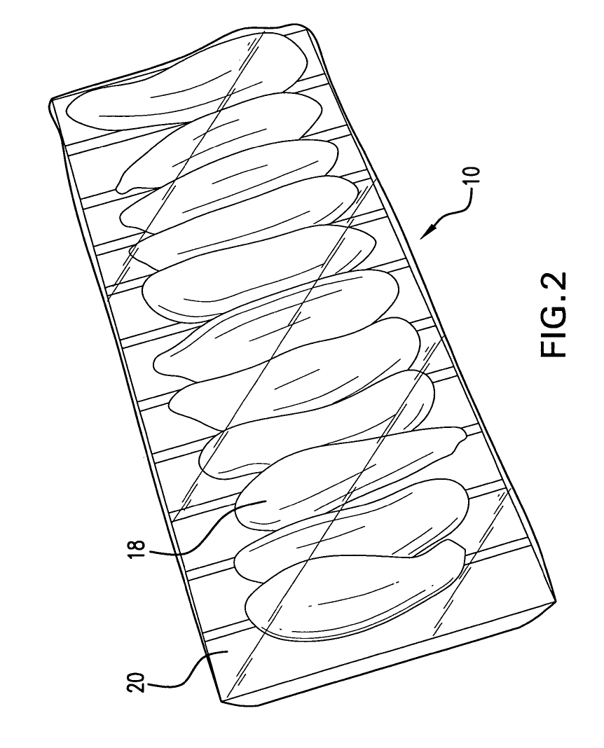

Referring now to FIG. 2, to further protect and preserve the freshness of the produce 18, a wrapping 20 is used to wrap the produce 18 loaded tray 10. Typically, the wrapping 20 acts as a barrier to separate produce 18 from the environment, e.g., moisture, air, and/or contaminants. Any suitable material may be used for wrapping 20. For example, it might take the form of tissue paper, waxed paper, plastic wrap, or aluminum foil. The exact material used for wrapping 20 will vary according to the type of produce being packed and transported, and the length and environment of the transport process (e.g., 1 day or 7 days, e.g., by refrigerated truck or open train car). For example, if it is desired to allow moisture to contact the produce 18 while it is packaged within the tray 10, a moisture-permeable material can be used. Alternatively, if it is desired that no moisture contacts the produce 18, a moisture-resistant or impermeable material can be used. Such wrappings are well known in the food packing industry. The USDA, Produce Marketing Association (PMA), BLUE BOOK CREDIT SERVICES and RED BOOK are resources for determining standards for transporting fresh produce.

In some embodiments, the space between the produce 18 and the wrapping 20 can be filled with a fluid such as an inert gas (e.g., nitrogen) to retard spoiling or ripening or ethylene to enhance ripening. Additionally, dessicant could be added to modulate humidity.

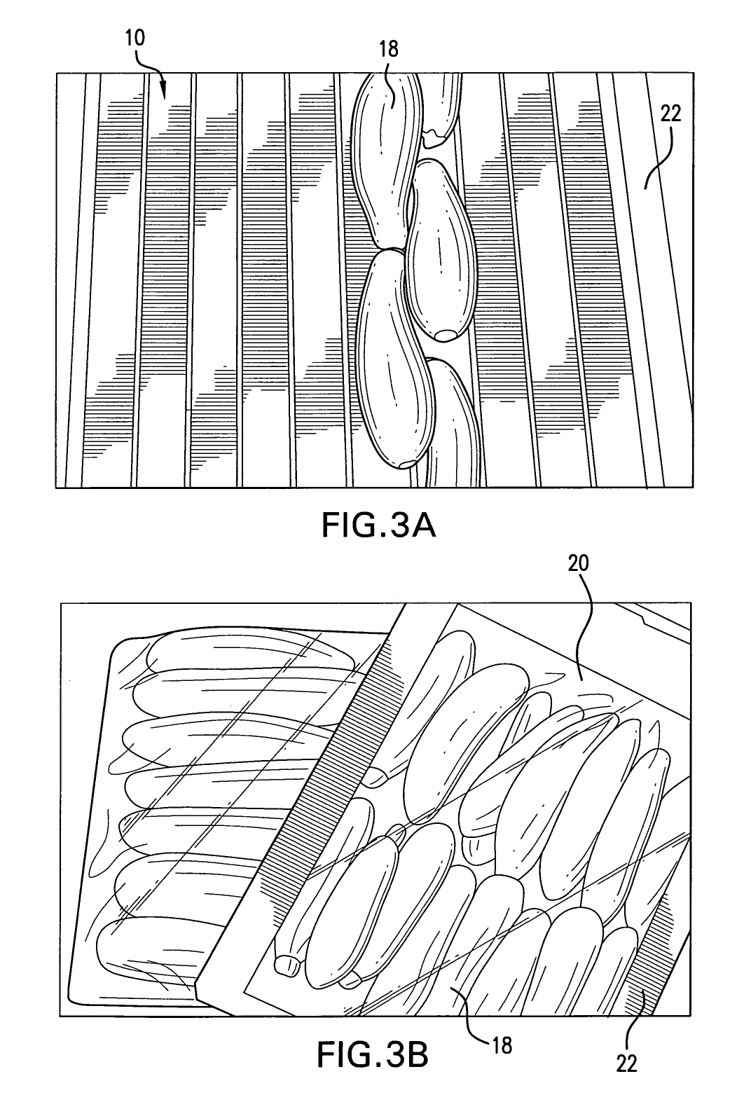

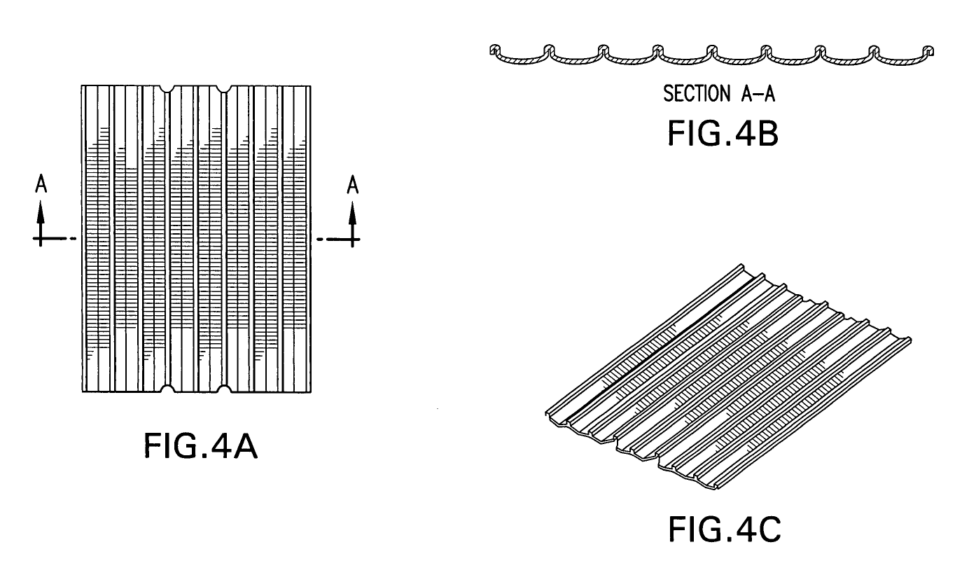

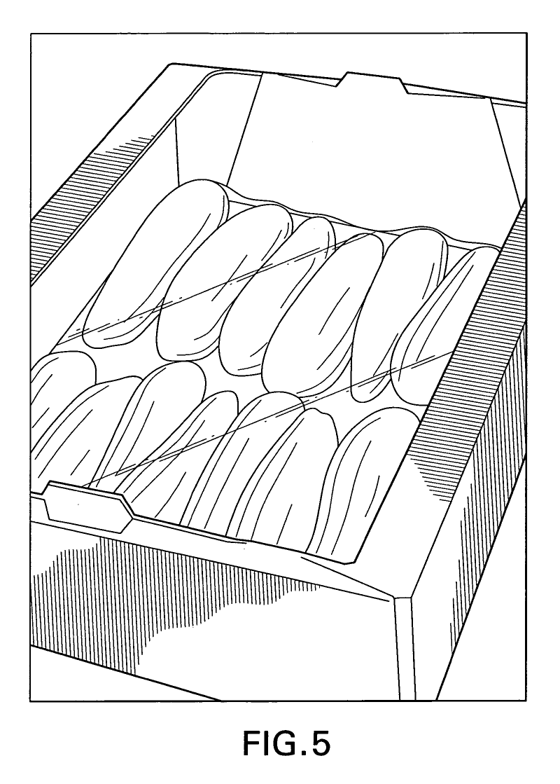

Referring to FIGS. 3, 4A, and 4B, two or more produce-containing trays can be stacked one atop another within a larger container, such as a cardboard carton 22 to facilitate storage and/or transport of the produce. The cardboard box or carton 22 is preferably formed of a corrugated or corrugated type cardboard having sufficient strength as to support the weight of several layers of produce. Such cartons are well known in the produce packing industry and have been employed for years in the shipping of produce. Particularly preferred are cartons that are formed of recyclable corrugated or corrugated type cardboard. Reusable plastic containers can also be used.

In a typical embodiment, the tray 10 is sized to fit in standard packing containers (e.g., footprint packing containers). The dimensions of the tray can be selected according to the size and shape of produce to be packed and by the size and shape of the container in which the trays are stacked. For instance, for zucchini or squash a typical tray 10 of the invention is about 0.635 (e.g., 0.630, 0.635, 0.640, 0.645, 0.650, 0.660, 0.670, 0.680, 0.690, 0.7, 0.75, 0.8, 0.85, 0.9, 0.95, 1.0) centimeter (cm) high as measured from the bottom of the tray 10 to the apex of the ridges 14 and the width of each channel 16 is about 3.5 cm (e.g, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2 cm). For packaging zucchini or squash in a standard packing container (e.g., carton), the tray 10 is about 32.86 cm (e.g., 32.0, 32.5, 32.86, 32.9, 33.0, 33.2, 33.4, 33.6, 33.8, 34.0, 34.1 cm) wide and about 35.56 cm (e.g., 35.0, 35.2, 35.56, 35.8, 36.0, 36.2, 36.4, 36.6, 36.8, 40.0 cm) long. By increasing the width of the channel 16 to approximately 3.81 cm, two additional pieces of zucchini or squash can be packed per layer. By decreasing the channel 16 width by approximately 3.175 cm, two fewer pieces of zucchini or squash can be packed per layer. For packing cucumbers, for example, a channel 16 width in the range of approximately 3.81 cm to approximately 5.1 cm is particularly useful.

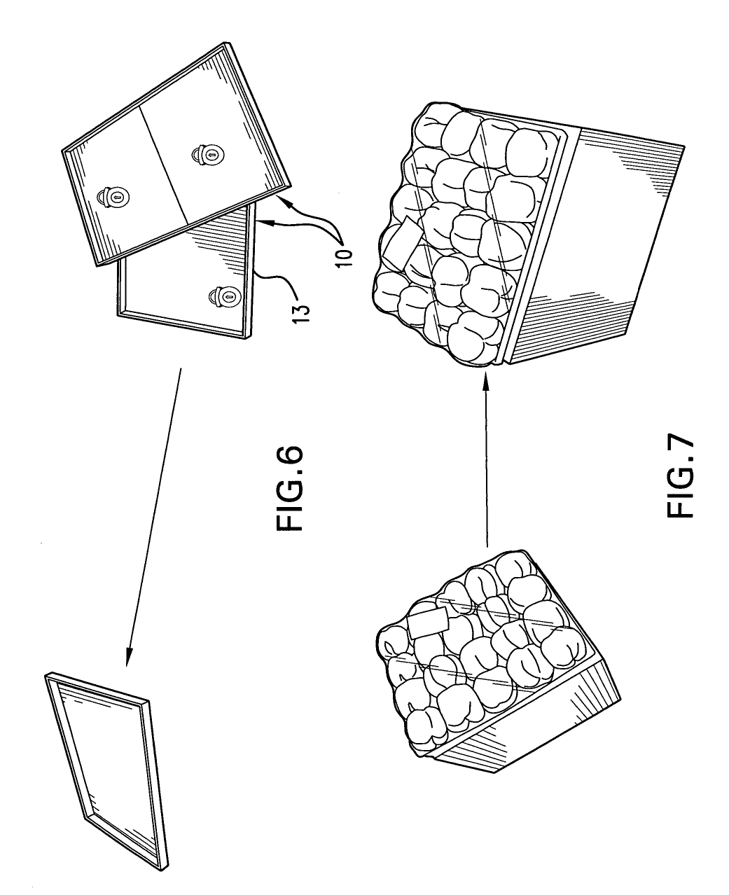

Referring now to FIGS. 6 and 7, another embodiment of a tray 10 of the invention is shown. In this embodiment, the tray 10 is a semi-rigid, one-piece structure formed by a base 12 from which four walls 13 extend, the tray 10 having a design similar to that of a cookie sheet. Like the trays 10 shown in FIGS. 1-5, tray 10 as shown in FIGS. 6 and 7 is sized to fit in standard packing containers (e.g., footprint packing containers) and the dimensions of the tray 10 can be selected according to the size and shape of produce to be packed and by the size and shape of the container in which the trays are stacked. For example, a tray 10 having a design similar to that of a cookie sheet (FIGS. 6 and 7) for packaging zucchini or squash in a standard packing container (e.g., carton) is about 32.86 cm (e.g., 32.0, 32.5, 32.86, 32.9, 33.0, 33.2, 33.4, 33.6, 33.8, 34.0, 34.1 cm) wide and about 35.56 cm (e.g., 35.0, 35.2, 35.56, 35.8, 36.0, 36.2, 36.4, 36.6, 36.8, 40.0 cm) long. The height of the tray 10 as measured from the bottom of the tray 10 to the tops of the walls 13 is in the range of about 0.635 cm to about 7.62 cm (e.g., 0.630, 1.0, 1.5, 2.0, 2.5, 3.0, 3.5, 4.0, 4.5, 5.0, 5.5, 6.0, 6.5, 7.0, 7.62, 8.0 cm). An advantage to this style of tray 10 is that it can be used to package any type or size of produce.

A typical tray as described herein can be configured to a 5-down footprint. The term “5-down” refers to how many trays can be assembled upon a standard pallet. For example, 5 stacks of single layer trays can be stacked 12 layers high resulting in 60 trays per pallet (e.g., 5Ti+12Hi). Standard 5-down footprint dimensions are: 57.79 (e.g., 57.15, 58.42, 59.06, 59.69) cm×37.47 (e.g., 36.83, 38.1, 38.735, 39.37) cm (minimum inside dimensions) and 60.48 (e.g., 60.33, 60.96, 61.6) cm×40.32 (e.g., 38.735, 39.37, 40.0, 40.32, 40.64, 41.275) cm (maximum outside dimensions). The tray shown in FIG. 7 is configured to fit a standard 1 and 1/9 (1 1/9) Bu (bushel) carton, an industry standard traditionally used to pack produce such as bell peppers, cucumbers, and eggplant, etc. This tray can also be used with ½ cartons squash (bushel cartons traditionally used for packing produce such as zucchini and squash).

The advantages of using a 5-down footprint are many and include the following. First, a smaller footprint (compared to a 4-down footprint, for example, which is primarily used to pack lettuce or cabbage which routinely weigh approximately 22.7 kilogram or more) may be more useful for “display-ready” applications where produce are placed directly on display at retail in the produce packaging tray. This merchandizing technique has shown to reduce in-store labor costs in the produce department. A smaller footprint may also be more suitable for higher value, lower volume produce. Also, 5-down produce packaging trays may be “mixed-stacked” on pallets in distribution. The ability to fit 10 down boxes on top of half a 5 down reduces distribution errors.

Lastly, 5-down produce packaging trays may be more ergonomic in handling than a 4-down tray, for example, as the smaller width dimension keeps the weight closer to the user's body, reducing back strain. Many different depths (i.e., height of the tray as measured from the bottom of the tray to the top of the tray) are possible depending on the produce to be packaged for optimizing shipping density and product protection. For example, a typical tray 10 for packing green bell peppers has a depth of approximately 5.715 cm, although a depth in the range of about 0.635 cm to about 10.16 cm is envisioned.

In some embodiments, a tray as described herein can further include a tab or handle for facilitating removal of the tray from a carton. A tab can be any flap, strap, loop or similar appendage that is operably coupled to the tray such that at least a portion of the tab is disposed exterior to the tray and can be grasped. To lift a tray having such a tab from a carton, the portion of the tab exterior to the tray is grasped and the tray is lifted from the carton. In some embodiments, a tray may have two or more tabs operably coupled thereto for facilitating lifting of the tray from a carton. A tab is also useful for rupturing the wrapping (e.g., a gas permeable plastic wrapping such as shrink wrap or plastic wrap) enveloping a tray. For example, a tray can have a tab operably coupled thereto such that when grasped with a first strength, the tab facilitates lifting of the tray from a carton. The tab, when grasped with a greater strength, ruptures the wrapping, providing access to the produce contained within the tray. A tab as described herein can be made of any suitable material (e.g., plastic, rubber, fabric) and can be rigid or flexible.

A typical method of packing fresh produce as described herein includes several steps, a subset of which are typically performed in a produce packing or packaging facility. A first step includes processing the produce to prepare it for packaging. Processing the produce includes any washing steps that are performed to remove dirt and any other undesirable particles or chemicals that may be present on the produce after it is harvested from the field. Processing also includes grading and sizing the produce prior to being loaded (e.g., hand-loaded) into the compartments or compartment formed in the tray of the invention. Processing may further include cooling the produce before it is packaged. Typically, either before or after packing, depending on climate and produce variety, the produce is cooled. After the produce is processed, it is loaded into trays. Produce is typically loaded into the trays by hand, but it can also be loaded by a machine. Once the produce is loaded into the trays, each tray is wrapped with a wrapping. Any suitable material may be used for wrapping. For example, it might take the form of tissue paper, waxed paper, plastic wrap, or aluminum foil. The exact material used for wrapping will vary according to the type of produce being packed and transported, and the length and environment of the transport process (e.g., 1 day or 7 days, e.g., by refrigerated truck or open train car). For example, if it is desired to allow moisture to contact the produce while it is packaged within the tray, a moisture-permeable material can be used. Alternatively, if it is desired that no moisture contacts the produce, a moisture-resistant or impermeable material can be used. If necessary, the loaded trays can be straightened or adjusted prior to being wrapped with a wrapping.

Each tray is then weighed, and can be affixed with a label providing such information as, for example, the weight and count range, product code, lot identification, customer information, scan bars, an item identification number, the packing date, and standard serving yields. Scan Bars provided on tray labels are useful for the packing company or the receiver of the produce and can aid in inventory management. Labels are also useful for “co-branding” with a preferred trade partner. Tray labels can have user-specific information such as “10−8 oz servings” or “10−226.8 gram servings” per 5 down tray. Labels can be printed directly on the wrapping with a secure-food-chain note, for example, or other certification. Because of the ability to affix labels to the wrapping, trays as described herein can provide more information for “commercial packs” than traditional produce packing trays provide. The information on the labels can be in two or more languages for use in multiple countries.

In a next step of the method, the wrapped and loaded trays are placed within a larger shipment container or carton. This container is typically then palletized (e.g., placed on a pallet, a portable platform for handling, storing, or moving materials or packaging). When filled, the shipment container or pallet is loaded into a vehicle (e.g, truck, train, or ship such as a sea-going ship) for transport to an entity purchasing the produce. Such an entity is typically a fresh produce wholesaler/retailer. Several aspects of systems and methods of the invention provide for transporting produce long distances to the wholesaler/retailer while maintaining the freshness and integrity of the produce. First, trays as described herein are sufficiently rigid to prevent damage to the produce caused by jostling and impact during transport. The channels of the trays in which the produce is placed also help protect the produce from damage caused by jostling and impact. By wrapping the produce-containing trays in a protective wrapping, the fruit is less likely to deteriorate, spoil or be contaminated by illness-causing agents during transport to the wholesaler/retailer. Thus, produce packaged using systems and methods as described herein have an increased likelihood of arriving at the wholesaler/retailer in a fresh, unspoiled state.

### OTHER EMBODIMENTS

It is to be understood that while the invention has been described in conjunction with the detailed description thereof, the foregoing description is intended to illustrate and not limit the scope of the invention, which is defined by the scope of the appended claims. The rigidity of the tray, for example, can range from semi-rigid to rigid. Other aspects, advantages, and modifications are within the scope of the following claims.

What is claimed is:

1. A method of enhancing the safety and quality of delicate produce to be transported from a packaging facility to a wholesaler or retailer, the method comprising the steps of, at a packaging facility:
a) washing a plurality of pieces of recently harvested produce;
b) positioning a first portion of the plurality of processed pieces of produce into at least a first tray and positioning a second portion of the plurality of processed pieces of produce into at least a second tray;
c) wrapping the first portion of the plurality of pieces of produce and the at least first tray with a first piece of material;
d) wrapping the second portion of the plurality of pieces of produce and the at least second tray with a second piece of material;
e) placing the wrapped first and second trays into a container with the at least second tray stacked on top of the at least first tray; and
f) loading the container aboard a vehicle for transport to the wholesaler or retailer.

2. The method of claim 1, wherein the delicate produce is selected from the group consisting of: squash, zucchini, tomatoes, cucumbers, bell peppers, green beans, jalapeno peppers, peaches, apples, eggplant, and corn.

3. The method of claim 1, wherein the wholesaler or retailer is located a distance greater than about 8 kilometers from the packaging facility.

4. The method of claim 1, wherein the wholesaler or retailer is located a distance greater than about 804 kilometers from the packaging facility.

5. The method of claim 1, wherein the at least first and second trays each comprise a semi-rigid structure formed by a base and a plurality of semi-rigid, uniformly spaced vertical ridges that each extend upwards from the base and that are disposed parallel to each other, the ridges disposed on the base to form a plurality of uniformly spaced channels that are each sized to accommodate at least two pieces of produce for storage and/or transport, the apex of each ridge being blunt.

6. The method of claim 1, wherein the step (b) of positioning a first portion of the plurality of pieces of produce into at least a first tray and positioning a second portion of the plurality of pieces of produce into at least a second tray comprises positioning each piece of produce such that the first portion of the plurality of pieces of produce are disposed longitudinally to each other in the at least first tray and the second portion of the plurality of pieces of produce are disposed longitudinally to each other in the at least second tray.

7. The method of claim 1, wherein the first piece of material is moisture impermeable.

8. The method of claim 1, wherein the first piece of material is moisture permeable.

9. The method of claim 1, wherein the first piece of material is gas permeable.

10. The method of claim 1, wherein the first piece of material is gas impermeable.

11. The method of claim 10, wherein the wrapped first tray comprises a gas that modulates ripening of the produce.

12. The method of claim 1, wherein the at least first and second trays each have a tab operably coupled thereto for facilitating lifting of the at least first and second trays from the container.

13. The method of claim 1, further comprising affixing a first label containing information about the first portion of the plurality of processed pieces to the at least first tray and affixing a second label containing information about the second portion of the plurality of processed pieces to the at least second tray.

14. The method of claim 1, wherein the step b) of positioning a first portion of the plurality of processed pieces of produce into at least a first tray and positioning a second portion of the plurality of processed pieces of produce into at least a second tray is performed manually.

15. The method of claim 1, wherein the step b) of positioning a first portion of the plurality of processed pieces of produce into at least a first tray and positioning a second portion of the plurality of processed pieces of produce into at least a second tray is performed automatically.
